(19) United States
(12) Patent Application Publication
(10) Pub. No.: US 2011/0117428 A1
(43) Pub. Date: May 19, 2011

(54) LITHIUM BATTERY AND METHOD OF MANUFACTURING THE SAME

(75) Inventors: Jin-Hyunk LIM, Yongin-si (KR); Jin-Sung KIM, Yongin-si (KR); Su-Hee HAN, Yongin-si (KR); Na-Rae PARK, Yongin-si (KR); Mi-Hyeun OH, Yongin-si (KR)

(73) Assignee: SAMSUNG SDI CO., LTD., Yongin-si (KR)

(21) Appl. No.: 12/916,298

(22) Filed: Oct. 29, 2010

(30) Foreign Application Priority Data
Nov. 19, 2009 (KR) 10-2009-0112196

(51) Int. Cl. H01M 10/02; H01M 4/58; H01M 10/04

(52) U.S. Cl. 429/188; 29/623.1

(57) ABSTRACT

A lithium battery including a negative electrode containing a negative active material into which lithium ions intercalate at an electrical potential equal to or greater than 1.2 V with respect to a potential of Li, and a method of manufacturing the lithium battery. According to one or more embodiments of the present invention, a lithium battery includes: a positive electrode; a negative electrode including a negative active material into which lithium ions intercalate at an electrical potential equal to or greater than 1.2 V with respect to a potential of Li; an electrolyte including a nonaqueous organic solvent and a lithium salt; and a first layer formed on at least one portion of the surface of the negative electrode by chemical reactions involving a first compound represented by Formula 1, elements contained in the electrolyte, and the negative active material.

### CLAIM OF PRIORITY

This application claims the benefit of Korean Patent Application No. 10-2009-0112196, filed on Nov. 19, 2009, in the Korean Intellectual Property Office, the disclosure of which is incorporated herein in its entirety by reference.

### BACKGROUND OF THE INVENTION

1. Field of the Invention

One or more embodiments of the present invention relate to a lithium battery including a negative electrode containing a negative active material into which lithium ions intercalate at an electrical potential equal to or greater than 1.2 V with respect to a potential of Li, and a method of manufacturing the lithium battery.

2. Description of the Related Art

A lithium battery converts chemical energy generated by electrochemical redox reactions of chemical substances into electrical energy, and includes a positive electrode, a negative electrode, and an electrolyte.

Recently, as electronic devices have increasingly high performance, batteries used therein are required to have high capacity and high output power. In order to manufacture a battery having high capacity, an active material having high capacity may be used.

In this regard, swelling of the lithium battery may influence lifetime and stability at high temperatures and needs to be reduced.

### SUMMARY OF THE INVENTION

One or more embodiments of the present invention include a lithium battery including a negative electrode containing a negative active material into which lithium ions intercalate at an electrical potential equal to or greater than 1.2 V with respect to a potential of Li, and having reduced swelling.

One or more embodiments of the present invention include a method of manufacturing the lithium battery.

Additional aspects will be set forth in part in the description which follows and, in part, will be apparent from the description, or may be learned by practice of the presented embodiments.

According to one or more embodiments of the present invention, a lithium battery includes: a positive electrode; a negative electrode including a negative active material into which lithium ions intercalate at an electrical potential equal to or greater than 1.2 V with respect to a potential of Li; an electrolyte including a nonaqueous organic solvent and a lithium salt; and a first layer formed on at least one portion of the surface of the negative electrode by chemical reactions involving a first compound represented by Formula 1, elements contained in the electrolyte, and the negative active material:

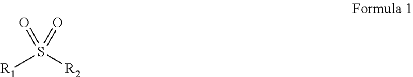

wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the group consisting of a hydroxyl group, a halogen atom, a C₁-C₃₀ alkyl group, and a C₁-C₃₀ alkoxy group; and —C(Q₁)=C(Q₂)(Q₃), provided that at least one of the R₁ and R₂ is —C(Q₁)=C(Q₂)(Q₃),

wherein Q₁ to Q₃ are each independently selected from the group consisting of a hydrogen atom; a halogen atom; a hydroxyl group; a C₁-C₁₀ alkyl group; and a C₁-C₁₀ alkoxy group.

R₁ and R₂ may be each independently selected from the group consisting of a hydrogen atom; —F; a methyl group; an ethyl group; a propyl group; a butyl group; a pentyl group; a hexyl group; a heptyl group; an octyl group; a methoxy group; an ethoxy group; a propoxy group; a butoxy group; a pentoxy group; a methyl group, an ethyl group, a propyl group, a butyl group, a pentyl group, a hexyl group, a heptyl group, an octyl group, a methoxy group, an ethoxy group, a propoxy group, a butoxy group, and a pentoxy group substituted with at least one selected from the group consisting of a hydroxyl group and —F; and —C(Q₁)=C(Q₂)(Q₃), wherein Q₁ to Q₃ are each independently selected from the group consisting of a hydrogen atom, —F, a methyl group, an ethyl group, a propyl group, a butyl group, a pentyl group, a hexyl group, a heptyl group, an octyl group, a methoxy group, an ethoxy group, a propoxy group, a butoxy group, and a pentoxy group.

At least one selected from the group consisting of R₁ and R₂ may be —CH═CH₂.

The negative active material may include lithium titanate.

The first layer may be formed by an aging process at a voltage within a range from about 1.5 V to about 2.8 V.

According to one or more embodiments of the present invention, a lithium battery includes: a positive electrode; a negative electrode including a negative active material into which lithium ions intercalate at an electrical potential equal to or greater than 1.2 V with respect to a potential of Li; an electrolyte including a nonaqueous organic solvent, a lithium salt, and the first compound; and a first layer formed on at least one portion of the surface of the negative electrode by chemical reactions involving the first compound, elements contained in the electrolyte, and the negative active material.

The negative active material may include lithium titanate.

The amount of the first compound in the electrolyte may be in the range of about 0.1 parts by weight to about 10 parts by weight based on 100 parts by weight of the electrolyte.

The first layer may be formed by an aging process at a voltage within a range from about 1.5 V to about 2.8 V.

According to one or more embodiments of the present invention, a lithium battery includes: a positive electrode; a negative electrode including a negative active material into which lithium ions intercalate at an electrical potential equal to or greater than 1.2 V with respect to a potential of Li; and an electrolyte including a nonaqueous organic solvent, a lithium salt, and the first compound.

The amount of the first compound in the electrolyte may be in the range of about 0.1 parts by weight to about 10 parts by weight based on 100 parts by weight of the electrolyte.

The negative active material may include lithium titanate.

According to one or more embodiments of the present invention, a method of manufacturing a lithium battery includes: preparing a lithium battery assembly including a positive electrode, a negative electrode including a negative active material into which lithium ions intercalate at an electrical potential equal to or greater than 1.2 V with respect to a potential of Li, and an electrolyte including a nonaqueous organic solvent, a lithium salt, and the first compound; and forming the lithium battery assembly, wherein the formation process of the lithium battery assembly includes aging the lithium battery assembly at a voltage within a range from about 1.5 V to about 2.8 V.

The first layer may be formed on at least one portion of the surface of the negative electrode by chemical reactions involving the first compound, the elements contained in the electrolyte, and the negative active material by the aging the lithium battery assembly at a voltage within a range from about 1.5 V to about 2.8 V.

The method may further include maintaining the lithium battery assembly at room temperature for about 48 to about 72 hours before aging the lithium battery assembly at a voltage within a range from about 1.5 V to about 2.8 V.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic perspective view of a lithium battery according to an embodiment of the present invention; and

FIG. 2 is a graph illustrating the thicknesses of lithium batteries manufactured according to Examples 1 to 3 and Comparative Examples 1 to 4.

FIG. 3 is a flow chart showing a method of manufacturing a lithium battery according to an embodiment of the present invention.

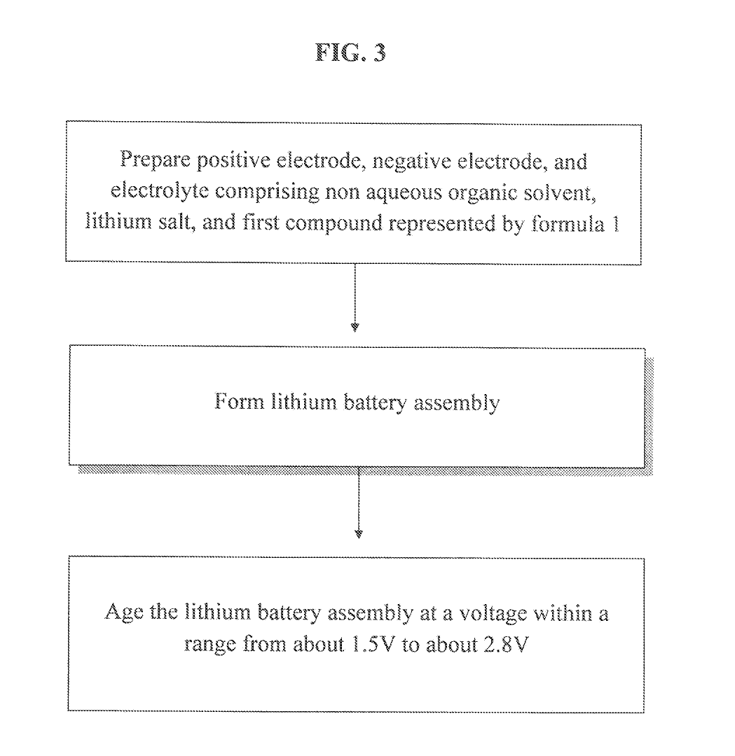

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

A lithium battery according to an embodiment of the present invention includes: a positive electrode; a negative electrode including a negative active material into which lithium ions intercalate at an electrical potential equal to or greater than 1.2 V with respect to a potential of Li; an electrolyte including a nonaqueous organic solvent and a lithium salt; and a first layer. In this regard, the first layer may be formed on at least one portion of the surface of the negative electrode by chemical reactions involving a first compound represented by Formula 1 below, elements contained in the electrolyte, and the negative active material:

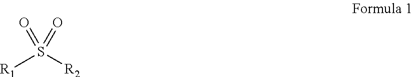

wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the group consisting of a hydroxyl group, a halogen atom, a C₁-C₃₀ alkyl group, and a C₁-C₃₀ alkoxy group; and —C(Q₁)=C(Q₂)(Q₃). In this regard, at least one selected from the group consisting of R₁ and R₂ is —C(Q₁)=C(Q₂)(Q₃).

For example, R₁ and R₂ may be each independently selected from the group consisting of a hydrogen atom; —F; a methyl group; an ethyl group; a propyl group; a butyl group; a pentyl group; a hexyl group; a heptyl group; an octyl group; a methoxy group; an ethoxy group; a propoxy group; a butoxy group; a pentoxy group; a methyl group, an ethyl group, a propyl group, a butyl group, a pentyl group, a hexyl group, a heptyl group, an octyl group, a methoxy group, an ethoxy group, a propoxy group, a butoxy group, and a pentoxy group substituted with at least one selected from the group consisting of a hydroxyl group and —F; —C(Q₁)=C(Q₂)(Q₃), but are not limited thereto.

Q₁ to Q₃ are each independently selected from the group consisting of a hydrogen atom; a halogen atom; a hydroxyl group; a C₁-C₁₀ alkyl group; and a C₁-C₁₀ alkoxy group. For example, Q₁ to Q₃ may each independently be a hydrogen atom, —F, a methyl group, an ethyl group, a propyl group, a butyl group, a pentyl group, a hexyl group, a heptyl group, an octyl group, a methoxy group, an ethoxy group, a propoxy group, a butoxy group, or a pentoxy group, but are not limited thereto.

For example, at least one selected from the group consisting of R₁ and R₂ may be —CH═CH₂. In the first compound, both of R₁ and R₂ may be —CH═CH₂ (see below formula) which is shown below, but are not limited thereto.

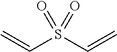

The first layer may exist on at least one portion of the surface of the negative electrode. The first layer may exist on the surface of the negative electrode in any of various forms. For example, the first layer may topically exist on portions of the surface of the negative electrode or may cover the entire surface of the negative electrode.

Meanwhile, the negative active material may include any negative active material into which lithium ions intercalate at an electrical potential equal to or greater than 1.2 V with respect to a potential of Li, for example, in the range of about 1.5 V to about 2.8 V.

For example, the negative active material may be lithium titanate.

The lithium titanate may include a spinel-type lithium titanate, an anatase-type lithium titanate, or a ramsdellite-type lithium titanate based on the crystalline structure thereof.

The negative active material may be represented by the formula Li₄₋ₓTi₅O₁₂ (0≦x≦3). For example, the negative active material may be Li₄Ti₅O₁₂, but is not limited thereto.

The first layer may be formed by an aging process at a voltage within a range to from about 1.5 V to about 2.8 V. The aging process will be described in more detail later. For example, when the negative active material includes lithium titanate and the electrolyte includes LiPF₆, EC, EMC and divinyl sulfone, the one or more compounds which participate in the reaction for forming the first layer may be at least one of lithium titanate, LiPF₆, EC, EMC and divinyl sulfone.

The elements of the first layer may be analyzed using any of various methods. For example, the elements of the first layer may be analyzed using Fourier Transform Infrared spectroscopy (FT-IR), but the analysis method is not limited thereto.

The first layer substantially inhibits continuous side reactions between the negative electrode and the electrolyte. Gas may build up in the lithium battery including the negative electrode described above, since the reactions between negative active material and the electrolyte continues while the lithium battery is operating and even while it is stored. The continuous reactions between the negative active material and the electrolyte cause swelling, and thus lifetime, stability at high temperatures, and capacity may be reduced.

However, since the first layer inhibits the reactions between the negative active material and the electrolyte, swelling may be substantially prevented. Thus, the lithium battery may have improved lifetime, stability at high temperatures, and capacity.

The nonaqueous organic solvent contained in the electrolyte may function as a medium through which ions participating in electrochemical reactions of the lithium battery pass.

The nonaqueous organic solvent may include a carbonate solvent, an ester solvent, an ether solvent, a ketone solvent, an alcohol solvent, or an aprotic solvent.

The carbonate solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), or the like, but is not limited thereto.

The ester solvent may be methyl acetate, ethyl acetate, n-propyl acetate, dimethyl acetate, methyl propionate, ethyl propionate, γ-butylolactone (GBL), decanolide, valerolactone, mevalonolactone, caprolactone, or the like, but is not limited thereto.

The ether solvent may be dibutyl ether, tetraglyme, diglyme, dimethoxy ethane, 2-methyltetrahydrofuran, tetrahydrofuran, or the like, but is not limited thereto.

The ketone solvent may be cyclohexanone, but is not limited thereto.

The alcohol solvent may be ethyl alcohol, isopropyl alcohol, or the like, but is not limited thereto.

The aprotic solvent may be a nitrile such as R—CN, wherein R is a C₂-C₂₀ linear, branched, or cyclic hydrocarbon-based moiety which may include an double bonded aromatic ring or an ether bond, an amide such as dimethylformamide, a dioxolane such as 1,3-dioxolane, a sulfolane, or the like, but is not limited thereto.

The nonaqueous organic solvents listed may be used alone or in a combination of at least two thereof as the nonaqueous organic solvent contained in the electrolyte. If used in a combination thereof, the ratio of the nonaqueous organic solvents may vary according to a desired performance of the lithium battery, and be obvious to those of ordinary skill in the art.

For example, the nonaqueous organic solvent contained in the electrolyte may be a mixture of ethylene carbonate (EC) and ethylmethyl carbonate (EMC) in a volume ratio of 3:7, or a mixture of EC, GBL, and EMC in a volume ratio of 3:3:4, but is not limited thereto.

The lithium salt contained in the electrolyte is dissolved in the nonaqueous organic solvent and functions as a source of lithium ions in the lithium battery to allow for basic operation of the lithium battery and accelerate migration of lithium ions between the positive electrode and the negative electrode.

The lithium salt may include at least one supporting electrolyte salt selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF_{2y+1}SO₂)(C_{y}F_{2y+1}SO₂), where x and y are respectively natural number, LiCl, LiI, and LiB(C₂O₄)₂, (lithium bis(oxalato) borate (LiBOB)).

The concentration of the lithium salt may be in the range of about 0.1 M to about 2.0 M. The concentration of the lithium salt may be in the range of about 0.6 M to about 2.0 M. If the concentration of the lithium salt is within the range described above, the electrolyte may have desired conductivity and viscosity, and thus lithium ions may be efficiently migrated.

The electrolyte may further include an additive capable of improving low temperature performance of the lithium battery. The additive may be a carbonate material or propane sultone (PS).

For example, the carbonate material may be vinylene carbonate (VC), a vinylene carbonate (VC) derivative having at least one substituent selected from the group consisting of a halogen atom, such as —F, —Cl, —Br, and —I, a cyano group (CN), and a nitro group (NO₂), or an ethylene carbonate (EC) derivative having at least one substituent selected from the group consisting of a halogen atom, such as —F, —Cl, —Br, and —I, a cyano group (CN), and a nitro group (NO₂), but is not limited thereto.

The additives listed may be used alone or in a combination of at least two thereof as the additive of the electrolyte.

The electrolyte may further include at least one additive selected from the group consisting of vinylene carbonate (VC), fluoroethylene carbonate (FEC), and propane sultone (PS).

The amount of the additive may be equal to or less than 10 parts by weight based on 100 parts by weight of the electrolyte. For example, the amount of the additive may be in the range of about 0.1 parts by weight to about 10 parts by weight based on 100 parts by weight of the electrolyte. If the amount of the additive is in the range of about 0.1 parts by weight to about 10 parts by weight based on 100 parts by weight of the electrolyte, low temperature performance of the lithium battery may be improved.

For example, the amount of the additive may be in the range of about 1 part by weight to about 5 parts by weight based on 100 parts by weight of the electrolyte, or in the range of about 2 parts by weight to about 4 parts by weight based on 100 parts by weight of the electrolyte, but is not limited thereto.

For example, the amount of additive may be 2 parts by weight based on 100 parts by weight of the electrolyte, but is not limited thereto.

Meanwhile, a compound for allowing reversible intercalation and deintercalation of lithium (lithiated intercalation compound) may be used as a positive active material contained in the positive electrode. For example, lithium ions may be intercalated into or deintercalated from the positive active material at an electrical potential equal to or greater than 3.0 V (vs Li/Li⁺).

Examples of the positive active material may include any of compounds represented by the following formulae, but are not limited thereto:

LiₐA_{1-b}X_{b}D₂ (where 0.95≦a≦1.1, and 0≦b≦0.5); LiₐE_{1-b}X_{b}O_{2-c}Dₑ (where 0.95≦a≦1.1, 0≦b≦0.5, and 0≦c≦0.05); LiE_{2-b}X_{b}O_{4-c}D_{c} (where 0≦b≦0.5 and 0≦c≦0.05); LiₐNi_{1-b-c}Co_{b}B_{c}D_{α} (where 0.95≦a≦1.1, 0≦b≦0.5, 0≦c≦0.05, and 0<α≦2); LiₐNi_{1-b-c}Co_{b}X_{c}O_{2-α}M_{α} (where 0.95≦a≦1.1, 0≦b≦0.5, 0≦c≦0.05, and 0<α<2); LiₐNi_{1-b-c}Co_{b}X_{c}O_{2-α}M₂ (where 0.95≦a≦1.1, 0≦b≦0.5, 0≦c≦0.05, and 0<α<2); LiₐNi_{1-b-c}Mn_{b}X_{c}D_{α} (where 0.95≦a≦1.1, 0≦b≦0.5, 0≦c≦0.05, and 0<α≦2); LiₐNi_{1-b-c}Mn_{b}X_{c}O_{2-α}M_{α} (where 0.95≦a≦1.1, 0≦b≦0.5, 0≦c≦0.05, and 0<α<2); LiₐNi_{1-b-c}Mn_{b}X_{c}O_{2-α}M₂ (where 0.95≦a≦1.1, 0≦b≦0.5, 0≦c≦0.05, and 0<α<2); LiₐNi_{b}E_{c}G_{d}O₂ (where 0.90≦a≦1.1, 0≦b≦0.9, 0≦c≦0.5, and 0.001≦d≦0.1); LiₐNi_{b}Co_{c}Mn_{d}GₑO₂ (where 0.90≦a≦1.1, 0≦b≦0.9, 0≦c≦0.5, 0≦d≦0.5, and 0.001≦e≦0.1); LiₐNiG_{b}O₂ (where 0.90≦a≦1.1 and 0.001≦b≦0.1); LiₐCoG_{b}O₂ (where 0.90≦a≦1.1 and 0.001≦b≦0.1); LiₐMnG_{b}O₂ (where 0.90≦a≦1.1 and 0.001≦b≦0.1); LiₐMn₂G_{b}O₄ (where 0.90≦a≦1.1 and 0.001≦b≦0.1); QO₂; QS₂; LiQS₂; V₂O₅; LiV₂O₅; LiZO₂; LiNiVO₄; Li_{(3-f)}J₂PO₄)₃ (where 0≦f≦2); Li_{(3-f)}Fe₂(PO₄)₃ (where 0≦f≦2); and LiFePO₄.

In the formulae, A is selected from the group consisting of nickel (Ni), cobalt (Co), manganese (Mn), and combinations thereof; X is selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D is selected from the group consisting of oxygen (O), fluorine (F), sulfur (S), phosphorus (P), and combinations thereof; E is selected from the group consisting of cobalt (Co), manganese (Mn), and combinations thereof; M is selected from the group consisting of fluorine (F), sulfur (S), phosphorus (P), and combinations thereof; G is selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q is selected from the group consisting of titanium (Ti), molybdenum (Mo), manganese (Mn), and combinations thereof; Z is selected from the group consisting of chromium (Cr), vanadium (V), iron (Fe), scandium (Sc), yttrium (Y), and combinations thereof; and J is selected from the group consisting of vanadium (V), chromium (Cr), manganese (Mn), cobalt (Co), nickel (Ni), copper (Cu), and combinations thereof.

A surface coating layer may be formed of at least one of the compounds listed. Alternatively, a mixture of the compounds listed without having a coating layer formed thereon and the compounds having a coating layer formed thereon, the compounds being selected from the above group, may be used. The coating layer may include at least one compound of a coating element selected from the group consisting of oxides, hydroxides, oxyhydroxides, oxycarbonates, and hydroxycarbonates of the coating element. The compounds for the coating layer may be amorphous or crystalline. The coating element contained in the coating layer may be magnesium (Mg), aluminium (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof.

The coating layer may be formed using any of various methods which may not adversely affect the physical properties of the positive active material. This is obvious to those of ordinary skill in the art, and thus a detailed description thereof will not be provided.

The positive active material may be a compound represented by Formula 3 below, but is not limited thereto:

Liₓ(NiₚCO_{q}Mnᵣ)O_{y} Formula 3

In Formula 3, x, p, q, r, and y refer to a molar ratio of the elements.

In Formula 3, 0.95≦x≦1.05, 0<p<1, 0<q<1, 0<r<1, p+q+r(?)=1, and 0<y≦2.

For example, 0.97≦x≦1.03, p may be 0.5, q may be 0.2, r may be 0.3, and y may be 2, but they are not limited thereto.

The positive active material may be LiNi_{0.5}CO_{0.2}Mn_{0.3}O₂, but is not limited thereto.

The positive active material may also be a compound represented by Formula 4 below, but is not limited thereto:

LiNiₜ₁COₜ₂Alₜ₃O₂ Formula 4

In Formula 4, t1+t2+t3=1, and t1=t2=t3, but they are not limited thereto.

The positive active material may also be a mixture of a compound of Formula 4 and LiCoO₂, but is not limited thereto. In the mixture of the compound of Formula 4 and LiCoO₂, the weight ratio of the compound of Formula 4 to LiCoO₂ may be in the range of about 1:9 to about 9:1, for example, about 3:7 to about 7:3. For example, the weight ratio of the compound of Formula 4 to LiCoO₂ may be 6:4, but is not limited thereto.

A lithium battery according to another embodiment of the present invention includes: a positive electrode; a negative electrode including a negative active material into which lithium ions intercalate at an electrical potential equal to or greater than 1.2 V with respect to a potential of Li; an electrolyte including a nonaqueous organic solvent, a lithium salt, and a first compound represented by Formula 1; and a first layer formed on at least one portion of the surface of the negative electrode by chemical reactions involving the first compound represented by Formula 1 described above, elements contained in the electrolyte, and the negative active material.

A positive active material contained in the positive electrode, the negative active material, the nonaqueous organic solvent, the lithium salt, the first compound, the first layer, and additives that may further be contained in the electrolyte are described above.

The electrolyte may further include the first compound.

The first compound contained in the electrolyte may be the first compound injected while preparing the lithium battery assembly, may not participate in the chemical reactions for forming the first layer, and may remain in the electrolyte, but is not limited thereto.

The amount of the first compound may be equal to or less than 10 parts by weight based on 100 parts by weight of the electrolyte. For example, the amount of the first compound may be in the range of about 0.1 parts by weight to about 10 parts by weight based on 100 parts by weight of the electrolyte. If the amount of the first compound in the electrolyte is within the range described above, swelling of the lithium battery may be substantially inhibited.

For example, the amount of the first compound may be in the range of about 0.1 parts by weight to about 5 parts by weight based on 100 parts by weight of the electrolyte. The amount of the first compound may be in the range of about 1 part by weight to about 3 parts by weight based on 100 parts by weight of the electrolyte, but is not limited thereto

For example, the amount of the first compound may be 1 part by weight, 2 parts by weight, or 3 parts by weight based on 100 parts by weight of the electrolyte, but is not limited thereto.

The existence and the amount of a target element contained in the electrolyte of the lithium battery to be analyzed, e.g., the first compound, may be measured by gas chromatography (GC).

In this regard, quantitative analysis of the target element may be performed using an internal standard method (ISTD) and/or an external standard method (ESTD).

According to the ISTD method, the quantitative analysis may be performed using ethyl acetate (EA) as an internal standard. Meanwhile, according to the ESTD method, the quantitative analysis may be performed using at least two standards per concentration for the target element to be analyzed, e.g., the first compound.

The method of quantitatively analyzing the target element, e.g., the first compound, contained in the electrolyte of the lithium battery may include: extracting the electrolyte from the lithium battery; performing GC on the extracted electrolyte using (an/the) ISTD or ESTD, and collecting data corresponding to the target element; and calculating the amount (% by weight or % by volume) of the target element from the data, but is not limited thereto.

Details regarding GC are disclosed in Principles of Instrumental Analysis, 5^{th} edition, Douglas A. Skoog, et al., pp. 701-722.

A lithium battery according to another embodiment of the present invention may include: a positive electrode; a negative electrode including a negative active material into which lithium ions intercalate at an electrical potential equal to or greater than 1.2 V with respect to a potential of Li; and an electrolyte including a nonaqueous organic solvent, a lithium salt, and a first compound represented by Formula 1 described above.

A positive active material contained in the positive electrode, the negative active material, the nonaqueous organic solvent, the lithium salt, the first compound, and additives that may be contained in the electrolyte are described above.

Lithium battery may be, for example, a lithium secondary battery, such as a lithium ion battery, a lithium ion polymer battery, a lithium sulfur battery, or the like, or a lithium primary battery, but is not limited thereto.

A method of manufacturing a lithium battery according to another embodiment of the present invention includes: preparing a lithium battery assembly including a positive electrode, a negative electrode including a negative active material into which lithium ions intercalate at an electrical potential equal to or greater than 1.2 V with respect to a potential of Li (vs Li/Li⁺), and an electrolyte including a nonaqueous organic solvent, a lithium salt, and a first compound represented by Formula 1; and forming the lithium battery assembly, wherein the forming of the lithium battery assembly includes aging the lithium battery assembly at a voltage within a range from about 1.5 V to about 2.8 V.

In the method, a positive active material contained in the positive electrode, the negative active material, the nonaqueous organic solvent, the lithium salt, the first compound, and additives that may further be contained in the electrolyte are described above.

The “lithium battery assembly” used herein means a lithium battery assembled before the formation process.

The method of manufacturing the lithium battery will be described in more detail.

The positive electrode may include a current collector and a positive active material layer disposed on the current collector. The positive electrode may be prepared according to the following process. A positive active material, a binder, and a solvent are mixed to prepare a positive active material composition. Then, the positive active material composition may be directly coated on the current collector, e.g., an aluminum (Al) current collector, and dried to prepare a positive electrode plate. Alternatively, the positive active material composition may be cast on a separate support, and a film formed thereon may be separated therefrom and may be laminated on the current collector to prepare the positive electrode plate. The method of manufacturing the positive electrode is obvious to those of ordinary skill in the art, and thus a detailed description thereof will not be provided. The solvent may be N-methylpyrrolidone, acetone, water, or the like, but is not limited thereto.

The positive active material contained in the positive electrode is described above.

The binder contained in the positive active material layer functions to strongly bind positive active material particles together and to the current collector. Examples of the binder include polyvinyl alcohol, carboxymethyl cellulose, hydroxypropyl cellulose, diacetyl cellulose, polyvinyl chloride, carboxylated polyvinyl chloride, polyvinyl fluoride, and a polymer having ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon, but are not limited to.

The positive active material layer may further include a conducting agent. The conducting agent is used to provide conductivity to the positive electrode. Any electrical conductive material that does not cause a chemical change in batteries may be used. Examples of the conducting agent include carbonaceous materials, such as natural graphite, artificial graphite, carbon black, acetylene black, ketchen black, carbon fibers, and the like; metal-based materials, such as copper (Cu), nickel (Ni), aluminum (Al), silver (Ag), and the like, in powder or fiber form, and conductive materials, including conductive polymers, such as a polyphenylene derivative, and mixtures thereof.

The current collector may be aluminum (Al), but is not limited thereto.

Similarly, a negative active material, a conducting agent, a binder, and a solvent may be mixed to prepare a negative active material composition. The negative active material composition may be directly coated on a current collector, e.g., a Cu current collector, or may be cast on a separate support and a negative active material film obtained therefrom may be laminated on the Cu current collector to obtain a negative electrode plate. In this regard, the amounts of the negative active material, the conducting agent, the binder and the solvent are those used in a common lithium battery.

Meanwhile, any material into which lithium ions intercalate at an electrical potential equal to or greater than 1.2 V with respect to a potential of Li may be used as the negative active material. The negative active material may be Li₄Ti₅O₁₂, but is not limited thereto. Meanwhile, any negative active material that is commonly used in the art, for example, natural graphite, a silicon/carbon complex, silicon metal, a silicon thin film, lithium metal, a lithium alloy, a carbonaceous material, or graphite, may also be used as the negative active material in addition to the material into which lithium ions intercalate at an electrical potential equal to or greater than 1.2 V with respect to a potential of Li.

The conducting agent, the binder, and the solvent in the negative active material composition may be the same as those in the positive active material composition. If desired, a plasticizer may be added to the positive active material composition and the negative active material composition to produce pores inside the electrode plates.

A separator may be interposed between the positive electrode and the negative electrode according to the type of the lithium battery. Any separator that is commonly used for lithium batteries may be used. In one embodiment, the separator may have low resistance to migration of ions in an electrolyte and have a high electrolyte-retaining ability. Examples of materials that may be used to form the separator include glass fiber, polyester, Teflon, polyethylene (PE), polypropylene, polytetrafluoroethylene (PTFE), and combinations thereof, each of which may be a nonwoven fabric or a woven fabric. A windable separator formed of a material such as polyethylene (PE) and polypropylene may be used for a lithium ion battery. A separator that may retain a large amount of an organic electrolyte may be used for a lithium ion polymer battery. These separators may be prepared according to the following process.

A polymer resin, a filler, and a solvent are mixed to prepare a separator composition. Then, the separator composition may be directly coated on an electrode, and then dried to form a separator film. Alternatively, the separator composition may be cast on a separate support and then dried to form a film, and the film separated from the support may be laminated on an electrode to form a separator film.

The polymer resin may be any material that is commonly used as a binder for an electrode plate. Examples of the polymer resin include a vinylidenefluoride/hexafluoropropylene copolymer, polyvinylidenefluoride, polyacrylonitrile, polymethylmethacrylate, and mixtures thereof, but are not limited thereto. For example, a vinylidenefluoride/hexafluoropropylene copolymer having about 8 to about 25 wt % of hexafluoropropylene may be used.

The separator is interposed between the positive electrode plate and the negative electrode plate to form a first assembly. The first assembly is wound or folded and then sealed in a cylindrical or rectangular battery case. Then, an electrolyte solution is injected into the battery case to complete the manufacture of the lithium battery assembly.

Alternatively, a plurality of such first assemblies may be stacked in a bi-cell structure, and then impregnated in an electrolyte. The obtained structure is placed in a pouch and sealed to complete the manufacture of the lithium battery assembly.

The “first assembly” used herein is an assembly including a positive electrode and a negative electrode without an electrolyte.

The electrolyte used in the preparing of the lithium battery assembly may include a nonaqueous organic solvent, a lithium salt, and the first compound represented by Formula 1. The nonaqueous organic solvent, the lithium salt, and the first compound are described above.

Then, the forming of the lithium battery assembly is performed. The forming of the lithium battery assembly may include aging the lithium battery assembly at a voltage within a range from about 1.8 V to about 2.5 V.

For example, the aging process may be performed at a voltage within a range from about 2.0 V to about 2.1 V, but is not limited thereto.

For example, the aging process may be performed for about 6 to about 48 hours, for example, for about 6 to about 24 hours, but is not limited thereto.

By aging the lithium battery assembly at a voltage within a range from about 1.8 V to about 2.5 V, the first layer formed as a result of chemical reactions among the first compound, the elements contained in the electrolyte, and the negative active material may be formed on at least one portion of the surface of the negative electrode.

Meanwhile, the first compound may or may not remain in the electrolyte of the lithium battery after the aging process of the lithium battery assembly at a voltage within a range from about 1.8 V to about 2.5 V. That is, the elements contained in the electrolyte of the lithium battery assembly (i.e., the electrolyte injected into the first assembly) and the composition ratio of the elements may be different from those of the electrolyte of the lithium battery obtained after the aging process.

Meanwhile, the lithium battery assembly may be maintained at room temperature (at about 25° C.) for about 48 hours to about 72 hours before aging the lithium battery assembly at a voltage within a range from about 1.5 V to about 2.8 V.

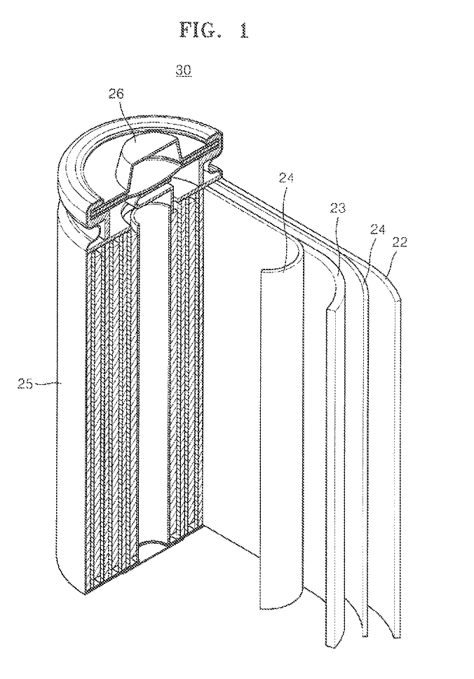

FIG. 1 is a schematic perspective view of a lithium battery according to an embodiment of the present invention. Referring to FIG. 1, a lithium battery 30 according to the present embodiment includes a positive electrode 23, a negative electrode 22, a separator 24 interposed between the positive electrode 23 and the negative electrode 22, an electrolyte (not shown) impregnated into the positive electrode 23, the negative electrode 22, and the separator 24, a battery case 25, and a sealing member 26 sealing the battery case 25. The lithium battery 30 is manufactured by sequentially stacking the positive electrode 23, the negative electrode 22 and the separator 24 on each other, winding the stack in a spiral form, and inserting the wound stack into the battery case 25.

Hereinafter, one or more embodiments of the present invention will be described in more detail with reference to the following examples. However, these examples are not intended to limit the scope of the one or more embodiments of the present invention.

### EXAMPLES

### Example 1

Li₄Ti₅O₁₂, as a negative active material, polyvinylidene fluoride (PVDF), as a binder, and acetylene black, as a conducting agent, were mixed in a weight ratio of 90:5:5 in N-methylpyrrolidone, as a solvent, to prepare a negative electrode slurry. The negative electrode slurry was coated on a copper (Cu)-foil to form a thin negative electrode plate having a thickness of 14 μm, dried at 135° C. for 3 hours or longer, and pressed to manufacture a negative electrode.

A mixture of LiCoO₂ and LiNiₜ₁COₜ₂Alₜ₃O₂, wherein t1+t2+t3=1 and t1=t2=t3, in a weight ratio of 6:4, as a positive active material, PVDF, as a binder, and carbon, as a conducting agent, were dispersed in a weight ratio of 96:2:2 in N-methylpyrrolidone, as a solvent, to prepare a positive electrode slurry. The positive electrode slurry was coated on an aluminum (Al)-foil to form a thin positive electrode plate having a thickness of 60 μm, dried at 135° C. for 3 hours or longer, and pressed to manufacture a positive electrode.

1.0M LiPF₆ and divinyl sulfone, that is, a compound of Formula 1, wherein both of R₁ and R₂ are —CH═CH₂, were added to a mixture of ethylenecarbonate (EC) and ethylmethyl carbonate (EMC), wherein a volume ratio of EC:EMC was 3:7, to prepare an electrolyte. In this regard, the amount of the divinyl sulfone was 1 part by weight based on 100 parts by weight of the electrolyte.

The negative electrode and the positive electrode were wound using a porous polyethylene (PE) film, as a separator, and pressed and placed into a battery case. Then, 3.5 ml of the electrolyte was injected into the battery case to manufacture a lithium battery assembly having a capacity of 500 mAh.

The thickness of the center of the lithium battery assembly measured using Nonius was 4.40 mm.

Then, the lithium battery assembly was maintained at room temperature (about 25° C.) for about 48 hours and aged at a voltage within a range from about 2.0 to about 2.1 V for about 12 hours to perform the forming of the lithium battery assembly to prepare a lithium battery.

### Example 2

A lithium battery assembly was manufactured in the same manner as in Example 1, except that the amount of divinyl sulfone was 2 parts by weight based on 100 parts by weight of the electrolyte.

The thickness of the lithium battery assembly measured in the same manner as in Example 1 was 4.44 mm.

Then, the forming of the lithium battery assembly was performed in the same manner as in Example 1 to prepare a lithium battery.

### Example 3

A lithium battery assembly was manufactured in the same manner as in Example 1, except that the amount of divinyl sulfone was 3 parts by weight based on 100 parts by weight of the electrolyte.

The thickness of the lithium battery assembly measured in the same manner as in Example 1 was 4.43 mm.

Then, the forming of the lithium battery assembly was performed in the same manner as in Example 1 to prepare a lithium battery.

### Comparative Example 1

A lithium battery assembly was manufactured in the same manner as in Example 1, except that divinyl sulfone was not used.

The thickness of the lithium battery assembly measured in the same manner as in Example 1 was 6.52 mm.

Then, the forming of the lithium battery assembly was performed in the same manner as in Example 1 to prepare a lithium battery.

### Comparative Example 2

A lithium battery assembly was manufactured in the same manner as in Example 1, except that propane sulton (PS) was used instead of divinyl sulfone, wherein the amount of PS was 2 parts by weight based on 100 parts by weight of the electrolyte.

The thickness of the lithium battery assembly measured in the same manner as in Example 1 was 4.32 mm.

Then, the forming of the lithium battery assembly was performed in the same manner as in Example 1 to prepare a lithium battery.

### Comparative Example 3

A lithium battery assembly was manufactured in the same manner as in Example 1, except that fluoroethylene carbonate (FEC) was used instead of divinyl sulfone, wherein the amount of FEC was 2 parts by weight based on 100 parts by weight of the electrolyte.

The thickness of the lithium battery assembly measured in the same manner as in Example 1 was 5.27 mm.

Then, the forming of the lithium battery assembly was performed in the same manner as in Example 1 to prepare a lithium battery.

### Comparative Example 4

A lithium battery assembly was manufactured in the same manner as in Example 1, except that vinylene carbonate (VC) was used instead of divinyl sulfone, wherein the amount of VC was 2 parts by weight based on 100 parts by weight of the electrolyte.

The thickness of the lithium battery assembly measured in the same manner as in Example 1 was 4.31 mm.

Then, the forming of the lithium battery assembly was performed in the same manner as in Example 1 to prepare a lithium battery.

### Evaluation Example

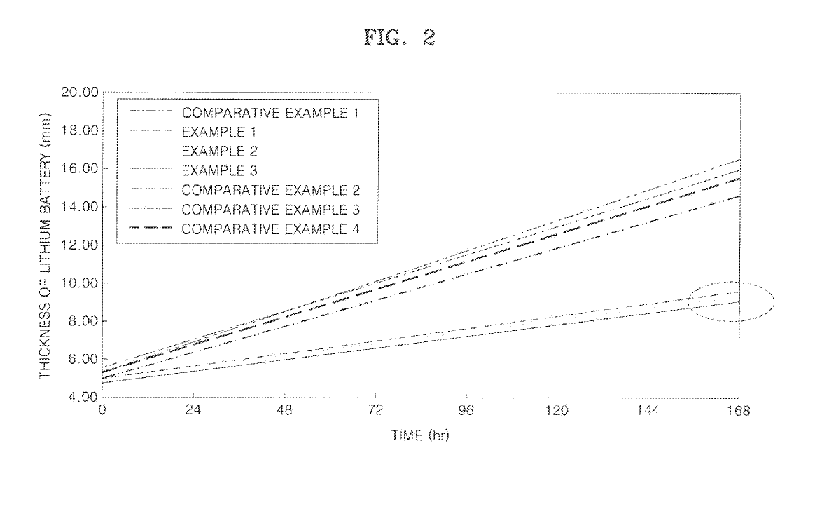

The thicknesses of the lithium batteries manufactured according to Examples 1 to 3 and Comparative Examples 1 to 4 were measured in the same manner as in Example 1 after maintaining the lithium batteries at 60° C. for 7 days, and the results are shown in FIG. 2 and Table 1.

TABLE 1

| | | Thickness after |
|---|---|---|
| | Initial | maintained |
| | thickness | at 60° C. |
| | (mm) | for 7 days (mm) |
| Example 1 | 4.40 | 9.12 |
| Example 2 | 4.44 | 9.21 |
| Example 3 | 4.43 | 9.29 |
| Comparative | 6.52 | 15.97 |
| Example 1 | | |
| Comparative | 4.32 | 14.37 |
| Example 2 | | |
| Comparative | 5.27 | 16.03 |
| Example 3 | | |
| Comparative | 4.31 | 15.99 |
| Example 4 | | |

Referring to Table 1 and FIG. 2, it was identified that the thicknesses of the lithium batteries manufactured according to Examples 1 to 3 were less changed than those of the lithium batteries manufactured according to Comparative Examples 1 to 4.

As described above, according to the one or more of the above embodiments of the present invention, the lithium battery may have high capacity and long lifetime.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A lithium battery comprising:
a positive electrode;
a negative electrode comprising a negative active material into which lithium ions intercalate at an electrical potential equal to or greater than 1.2 V with respect to a potential of Li;
an electrolyte comprising a nonaqueous organic solvent and a lithium salt; and
a first layer formed on at least one portion of the surface of the negative electrode by chemical reactions involving a first compound represented by Formula 1, described below, one or more compounds contained in the electrolyte, and the negative active material: 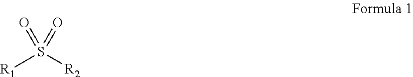
wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the group consisting of a hydroxyl group, a halogen atom, a C₁-C₃₀ alkyl group, and a C₁-C₃₀ alkoxy group; and —C(Q₁)=C(Q₂)(Q₃), provided that at least one of the R₁ and R₂ is —C(Q₁)=C(Q₂)(Q₃),
wherein Q₁ to Q₃ are each independently selected from the group consisting of a hydrogen atom; a halogen atom; a hydroxyl group; a C₁-C₁₀ alkyl group; and a C₁-C₁₀ alkoxy group.

2. The lithium battery of claim 1, wherein R₁ and R₂ are each independently selected from the group consisting of a hydrogen atom; —F; a methyl group; an ethyl group; a propyl group; a butyl group; a pentyl group; a hexyl group; a heptyl group; an octyl group; a methoxy group; an ethoxy group; a propoxy group; a butoxy group; a pentoxy group; a methyl group, an ethyl group, a propyl group, a butyl group, a pentyl group, a hexyl group, a heptyl group, an octyl group, a methoxy group, an ethoxy group, a propoxy group, a butoxy group, and a pentoxy group substituted with at least one selected from the group consisting of a hydroxyl group and —F; and —C(Q₁)=C(Q₂)(Q₃), wherein Q₁ to Q₃ are each independently selected from the group consisting of a hydrogen atom, —F, a methyl group, an ethyl group, a propyl group, a butyl group, a pentyl group, a hexyl group, a heptyl group, an octyl group, a methoxy group, an ethoxy group, a propoxy group, a butoxy group, and a pentoxy group.

3. The lithium battery of claim 1, wherein at least one of R₁ and R₂ is —CH═CH₂.

4. The lithium battery of claim 1, wherein the negative active material comprises lithium titanate.

5. The lithium battery of claim 1, wherein the first layer is formed by an aging process at a voltage within a range from about 1.5 V to about 2.8 V.

6. A lithium battery comprising:
a positive electrode;
a negative electrode comprising a negative active material into which lithium ions intercalate at an electrical potential equal to or greater than 1.2 V with respect to a potential of Li;
an electrolyte comprising a nonaqueous organic solvent, a lithium salt, and a first compound represented by Formula 1, described below; and
a first layer formed on at least one portion of the surface of the negative electrode by chemical reactions involving a first compound represented by Formula 1 below, one or more compounds contained in the electrolyte, and the negative active material: 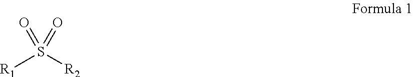
wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the
group consisting of a hydroxyl group, a halogen atom, a C₁-C₃₀ alkyl group, and a C₁-C₃₀ alkoxy group; and —C(Q₁)=C(Q₂)(Q₃), provided that at least one of the R₁ and R₂ is —C(Q₁)=C(Q₂)(Q₃),
wherein Q₁ to Q₃ are each independently selected from the group consisting of a hydrogen atom; a halogen atom; a hydroxyl group; a C₁-C₁₀ alkyl group; and a C₁-C₁₀ alkoxy group.

7. The lithium battery of claim 6, wherein R₁ and R₂ are each independently selected from the group consisting of a hydrogen atom; —F; a methyl group; an ethyl group; a propyl group; a butyl group; a pentyl group; a hexyl group; a heptyl group; an octyl group; a methoxy group; an ethoxy group; a propoxy group; a butoxy group; a pentoxy group; a methyl group, an ethyl group, a propyl group, a butyl group, a pentyl group, a hexyl group, a heptyl group, an octyl group, a methoxy group, an ethoxy group, a propoxy group, a butoxy group, and a pentoxy group substituted with at least one selected from the group consisting of a hydroxyl group and —F; and —C(Q₁)=C(Q₂)(Q₃), wherein Q₁ to Q₃ are each independently selected from the group consisting of a hydrogen atom, —F, a methyl group, an ethyl group, a propyl group, a butyl group, a pentyl group, a hexyl group, a heptyl group, an octyl group, a methoxy group, an ethoxy group, a propoxy group, a butoxy group, and a pentoxy group.

8. The lithium battery of claim 6, wherein at least one of R₁ and R₂ is —CH═CH₂.

9. The lithium battery of claim 6, wherein the negative active material comprises lithium titanate.

10. The lithium battery of claim 6, wherein the amount of the first compound in the electrolyte is in the range of about 0.1 parts by weight to about 10 parts by weight based on 100 parts by weight of the electrolyte.

11. The lithium battery of claim 6, wherein the first layer is formed by an aging process at a voltage within a range from about 1.5 V to about 2.8 V.

12. A lithium battery comprising:
a positive electrode;
a negative electrode comprising a negative active material into which lithium ions intercalate at an electrical potential equal to or greater than 1.2 V with respect to a potential of Li; and
an electrolyte comprising a nonaqueous organic solvent, a lithium salt, and a first compound represented by Formula 1, described below: 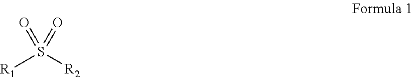
wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the group consisting of a hydroxyl group, a halogen atom, a C₁-C₃₀ alkyl group, and a C₁-C₃₀ alkoxy group; and —C(Q₁)=C(Q₂)(Q₃), provided that at least one of R₁ and R₂ is —C(Q₁)=C(Q₂)(Q₃),
wherein Q₁ to Q₃ are each independently selected from the group consisting of a hydrogen atom, a halogen atom, a hydroxyl group, a C₁-C₁₀ alkyl group, and a C₁-C₁₀ alkoxy group.

13. The lithium battery of claim 12, wherein R₁ and R₂ are each independently selected from the group consisting of a hydrogen atom; —F; a methyl group; an ethyl group; a propyl group; a butyl group; a pentyl group; a hexyl group; a heptyl group; an octyl group; a methoxy group; an ethoxy group; a propoxy group; a butoxy group; a pentoxy group; a methyl group, an ethyl group, a propyl group, a butyl group, a pentyl group, a hexyl group, a heptyl group, an octyl group, a methoxy group, an ethoxy group, a propoxy group, a butoxy group, and a pentoxy group substituted with at least one selected from the group consisting of a hydroxyl group and —F; and —C(Q₁)=C(Q₂)(Q₃), wherein Q₁ to Q₃ are each independently selected from the group consisting of a hydrogen atom, —F, a methyl group, an ethyl group, a propyl group, a butyl group, a pentyl group, a hexyl group, a heptyl group, an octyl group, a methoxy group, an ethoxy group, a propoxy group, a butoxy group, and a pentoxy group.

14. The lithium battery of claim 12, wherein at least one of R₁ and R₂ is —CH═CH₂.

15. The lithium battery of claim 12, wherein the amount of the first compound in the electrolyte is in the range of about 0.1 parts by weight to about 10 parts by weight based on 100 parts by weight of the electrolyte.

16. The lithium battery of claim 12, wherein the negative active material comprises lithium titanate.

17. A method of manufacturing a lithium battery, the method comprising:
preparing a lithium battery assembly comprising a positive electrode, a negative electrode comprising a negative active material into which lithium ions intercalate at an electrical potential equal to or greater than 1.2 V with respect to a potential of Li, and an electrolyte comprising a nonaqueous organic solvent, a lithium salt, and a first compound represented by Formula 1, described below; and
forming the lithium battery assembly,
wherein the formation process of the lithium battery assembly comprises aging the lithium battery assembly at a voltage within a range from about 1.5 V to about 2.8 V: 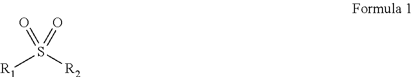
wherein R₁ and R₂ are each independently selected from the group consisting of a hydrogen atom; a halogen atom; a hydroxyl group; a C₁-C₁₀ alkyl group; a C₁-C₁₀ alkoxy group; a C₁-C₁₀ alkyl group and C₁-C₁₀ alkoxy group substituted with at least one selected from the group consisting of a hydroxyl group, a halogen atom, a C₁-C₃₀ alkyl group, and a C₁-C₃₀ alkoxy group; and —C(Q₁)=C(Q₂)(Q₃), provided that at least one of the R₁ and R₂ is —C(Q₁)=C(Q₂)(Q₃),
wherein Q₁ to Q₃ are each independently selected from the group consisting of a hydrogen atom; a halogen atom; a hydroxyl group; a C₁-C₁₀ alkyl group; and a C₁-C₁₀ alkoxy group.

18. The method of claim 17, wherein at least one of R₁ and R₂ is —CH═CH₂.

19. The method of claim 17, wherein a first layer is formed on at least one portion of the surface of the negative electrode by chemical reactions involving the first compound, one or more compounds contained in the electrolyte, and the negative active material while aging the lithium battery assembly at a voltage within a range from about 1.5 V to about 2.8 V.

20. The method of claim 17, further comprising maintaining the lithium battery assembly at room temperature for about 48 to about 72 hours before aging the lithium battery assembly at a voltage within a range from about 1.5 V to about 2.8 V.
